(19) United States
(12) Patent Application Publication
(10) Pub. No.: US 2016/0021482 A1
(43) Pub. Date: Jan. 21, 2016

(54) MANAGEMENT OF TRANSIENT NODES AND MULTIPLE CAPABILITY INSTANCES IN WIRELESS M2M NETWORKS

(71) Applicant: Cluster Wireless LLC, San Diego, CA (US)

(72) Inventors: Prem Jothipragasam Kumar, San Diego, CA (US); Thomas O'Neill, La Jolla, CA (US); Robbin David Hughes, Plano, TX (US); Ramesh Rajasekaran, Chennai (IN)

(73) Assignee: Cluster Wireless LLC

(21) Appl. No.: 14/334,618

(22) Filed: Jul. 17, 2014

(51) Int. Cl. H04W 4/00

(52) U.S. Cl. CPC H04W 4/005; H04W 4/008; H04W 88/12

(57) ABSTRACT

The embodiments herein provide a method and system for automatically optimizing a Machine-to-Machine (M2M) network including a central controller configured to communicate with a plurality of nodes controlled using one or more hubs. The method including receiving, at the central controller, one or more parameters associated with each node from the one or more hubs in the M2M network, wherein the one or more hubs requests each node using a short range communication to receive the one or more parameters from each node. Further, the method includes identifying, at the central controller, a capability of each node based on a plurality of rules. Furthermore, the method includes performing one or more actions in the one or more hubs to automatically optimize the M2M network based on the identified capability of each node in the M2M network.

### TECHNICAL FIELD

The embodiment herein relate to a wireless Machine-to-Machine (M2M) network and, more particularly to a system and method for management of transient nodes and multiple capability instances in the wireless M2M networks.

### BACKGROUND

Modern Machine-to-Machine (M2M) communications has expanded beyond a one-to-one connection and changed into a wireless system of M2M networks. The M2M networks generally implement a dynamic topology in which devices are associated and disassociated with each other. The roles and responsibilities of each such device, more particularly transient devices, may change over time and there remain unique challenges to developing, deploying, configuring, and managing the M2M networks.

Different systems and methods are proposed to develop, deploy, and manage devices and its associations in the M2M networks. The existing systems and methods use a back-end server to perform development, deployment, configuration, and management of the devices in the M2M network. The back-end server includes a web application using configuration tables, which provides limited information about the devices and overall M2M network. Further, reconfiguration, association, disassociated addition, and deletion of the devices in the M2M network includes manual configuration operation or a combination of manual intervention with limited computer-generated reconfiguration, association, disassociated addition, and deletion of the devices.

Thus there remains a need of a robust and simple system and method for automatically management of devices, more particularly transient devices, and multiple capability instances in the wireless M2M networks with minimum or no user intervention.

### BRIEF DESCRIPTION OF THE FIGURES

The embodiments herein will be better understood from the following detailed description with reference to the drawings, in which:

FIG. 1 illustrates generally, among other things, a high level overview of a Machine-to-Machine (M2M) network, according to embodiments described herein;

FIG. 2 expands features and functions of the M2M network 100, according to embodiments described herein

FIG. 3 is a sequence diagram illustrating generally various operations performed by central controller and hub as described in the FIGS. 1 and 2, according to embodiments disclosed herein; and

FIG. 4 is a flow chart illustrating a method for optimizing automatically optimizing the M2M network, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for automatically optimizing a Machine-to-Machine (M2M) network including a central controller configured to communicate with a plurality of nodes controlled using one or more hubs. The method including receiving, at the central controller, one or more parameters associated with each node from the one or more hubs in the M2M network, wherein the one or more hubs requests each node using a short range communication to receive the one or more parameters from each node. Further, the method includes identifying, at the central controller, a capability of each node based on a plurality of rules. Furthermore, the method includes performing one or more actions in the one or more hubs to automatically optimize the M2M network based on the identified capability of each node in the M2M network.

The proposed system and method is simple, reliable, and robust for automatically optimizing the M2M based on the capabilities of the nodes present in the M2M network. The system and methods can be used to automatically analyze, plot, evaluate, configure, reconfigure, associate, disassociate, add, and delete various nodes in the entire M2M network. Error-free and fast configurations/reconfigurations can be performed compared to manual and semi-manual configurations/reconfigurations of the M2M networks with minimum or no user intervention. The automatic nature of the system and method may improve the performance of the communication links in the in the M2M network and improve the overall network performance with significantly decreased time and cost. The system and method can be used to identify the capabilities of the nodes and associated sensors present in the M2M network using a set of rules defined in the central controller. The identification of the capabilities of the nodes based on plurality of rules including the user preferences and requirements improves the efficiency and accuracy in determination of capabilities. Such a rule-based system can be used to increase the system response time and provide effective services to the user. The system and method can be used to frequent monitor the various parameters of the nodes using short range communication between the hub and the nodes and automatically optimize the M2M network to increase performance with less cost. Administrators can easily try various network topologies in simulation and can easily reach to an optimal solution to increase availability of resources in the network. The frequent monitoring of the nodes using the hub allows the central controller to identify the availability of the transient nodes in the M2M network and automatically perform various actions to optimize the M2M network.

Further, the system and method can be used to perform various actions to optimize the M2M network based on the identified capability of the nodes. The automatic optimization of M2M network based on the detection of changing node parameter reduces the overall cost of operating the M2M network. Unlike conventional methods and systems, which require user intervention for identifying the changing parameters and manually perform one or more actions to optimize the M2M network, the proposed method and system provides an automatic mechanism to optimize the M2M network with minimal user intervention. Further, the proposed method and system can be used to improve the overall performance of the M2M network in presence of mobile sensors or sensors with transient availability. Furthermore, the proposed system and method can be implemented on the existing infrastructure and may not require extensive set-up or instrumentation.

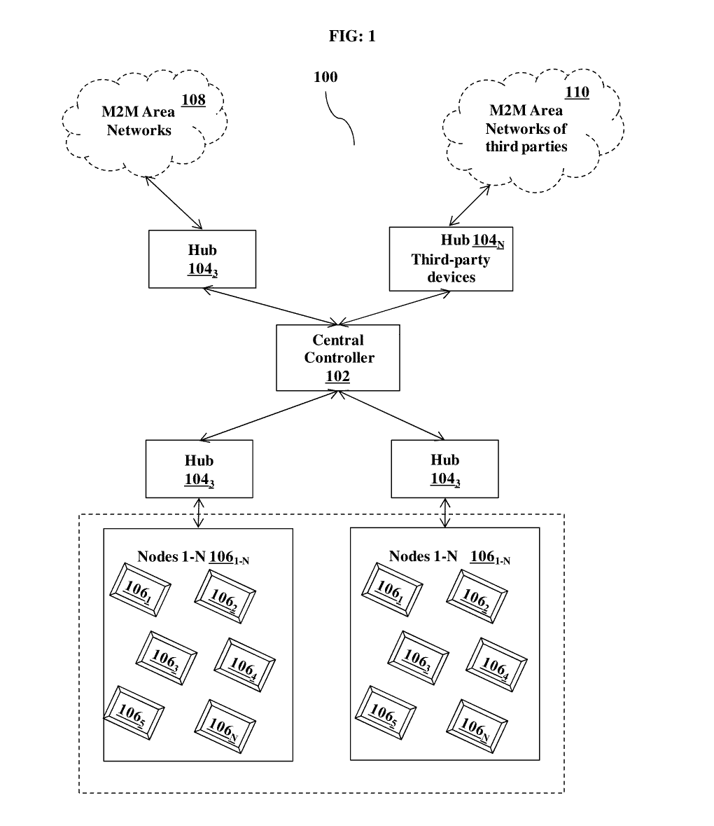

Referring now to the drawings, and more particularly to FIGS. 1 through 4, where similar reference characters denote corresponding features consistently throughout the figures, there are shown embodiments.

FIG. 1 illustrates generally, among other things, a Machine-to-Machine (M2M) network 100 in which the present invention is embodied, according to embodiments described herein. In an embodiment, the M2M network 100 can include a central controller 102, one or more hubs 104_{1-N} (hereafter referred to as hub(s) 104), and one or more nodes 106_{1-N} (hereafter referred as node(s) 106).

The M2M network 100 described herein can be for example, but not limited to, wireless network, wire line network, public network such as the Internet, private network, Global System for Mobile Communication Network (GSM) network, General Packet Radio Network (GPRS), local area network (LAN), Wide Area Network (WAN), Metropolitan Area Network (MAN), cellular network, Public Switched Telephone Network (PSTN), Personal Area Network (PAN), a combination thereof, or any other network.

The node 106 can functions as a data acquisition unit to which the conventional sensors can be added. The nodes 106 described herein can include for example, but not limited to, M2M devices, M2M gateways or associated networks (for example, the M2M area network 108), traffic concentrators, third-party service providers or associated networks (for example, M2M area networks of third-parties 110), and various other networks sources (not shown) such as routers, hubs, collectors, sensors, meters, back-up server(s), storage devices, and the like. The nodes 106 can be configured to provide one or more services in the M2M network 100. Examples of such services provided by nodes 106 can include, but is not limited to, monitoring systems, detection systems, measurement systems, and the like. The nodes 106 can be configured to include appropriate interfaces such to communicate with the hubs 104 and among each other over the M2M network 100.

Each node or a group of nodes in the M2M network 100 can be controlled by one or more hubs 104. The hub 104 described herein can include for example, but not limited to, a switch, a repeater hub, an active hub, a network hub, and the like. In an embodiment, the hub 104 can be a mobile hub configured to move and communicate with the nodes 106 in the M2M network 100. Each hub 104 can be configured to capture parameters associated with the corresponding nodes 106 in the M2M network 100 using short range communications. In an embodiment, the short range communicate described herein can include, but is not limited to Bluetooth, ZigBee, Z-wave, Wireless Universal Serial Bus (USB), Ultra-wideband (UWB), Wi-Fi, Wi-Fi Direct, Near field communication (NFC), Radio-frequency identification (RFID), and the like. The parameters described herein can include for example, but not limited to, node availability, node characteristics, services offered by the node, the service availability, the service characteristics, the service quality, communication channel, profile data, user preferences, usage data, range, speed, bandwidth, workload, security data, and congestion in the M2M network 100. Each hub 104 can capture the parameters associated with the corresponding nodes 106 indirectly using one or more concentrators (or any other collector devices) or can directly using interfaces with the nodes 106. Further, the hub 104 can be configured to consolidate the received parameters from the nodes 106, and send the consolidated parameters to the central controller 102.

Further, each hub 104 in the M2M network 100 can include information related to the nodes such for example, but not limited to, each node IP address, MAC address, changes in network states such as new nodes registering, nodes unregistering, node paths changing, traffic associated with the nodes, multiple routes and paths associated with each node, and the like. The information is maintained and distributed to other hubs 104 using the central controller 102. In an embodiment, the central controller 102 described herein can include for example, but not limited to, gateway device, router, hub, computer, laptop, wireless electronic device, personal digital assistance, smart phone, and the like.

Furthermore, the central controller 102 can be configured to optimize the M2M network based on the received parameters associated with each node in the M2M network 100. Further, the central controller 102 can be configured to include or couples to one or more databases describing current state information of the each node and the historical states of each node in the M2M network 100. The historical states information of the M2M network 100 can be used to reconstruct the network topology at any particular point.

Furthermore, the central controller 102 can be configured to frequently monitor a plurality of parameters associated with each node 106 through the hubs 104. Based on the received parameters, the central controller 102 analyzes the received parameters to identify the capability of each node present in the M2M network 100 using a plurality of rules. In an embodiment, a value (on scale of 1 to 10) can be assigned to each parameter based on the one or more applicable rules, such as to later used by the central controller 102 for performing various actions to optimize the M2M network 100. In an example, the rules can include elements such as for example, but not limited to, node availability, node characteristics, services offered by the node, the service availability, the service characteristics, the service quality, communication channel, profile data, user preferences, usage data, range, speed, bandwidth, workload, security data, user historic activities, user interest, user frequent services, user service usage, user service cost plans, user device battery level, communication link/channel, profile, service quality requirement data, range, speed, bandwidth, workload, congestion, or any other elements indicating the user requirements and needs. Further, the central controller 102 is configured to display the received parameters from each node in M2M network 100 for user viewing. Based on the identified capabilities, the central controller 102 can perform actions to optimize the M2M network. Any change in the node parameters is reflected on the display at the central controller 102. A standard and easy-to-use interface can be provided to an administrators or any other user to manage the M2M network 100, such as to allow the user to easily try various network topologies in simulation and to easily reach to an optimal solution to automatically optimize the M2M network 100 with minimum or no user intervention.

Further, the FIG. 1 shows a limited overview of the M2M network 100 but, it is to be understood that another embodiments are not limited thereto. Furthermore, the M2M network 100 can include different modules communicating among each other along with other hardware or software components. For example, the component can be, but not limited to, a process running in the node, the hub, or the central controller, an executable process, a thread of execution, a program embodied in a microprocessor, microcontroller or combination thereof. By way of illustration, both an application running on the central controller and the central controller can be the component. Similarly, the application running on the hub and the hub can be the component.

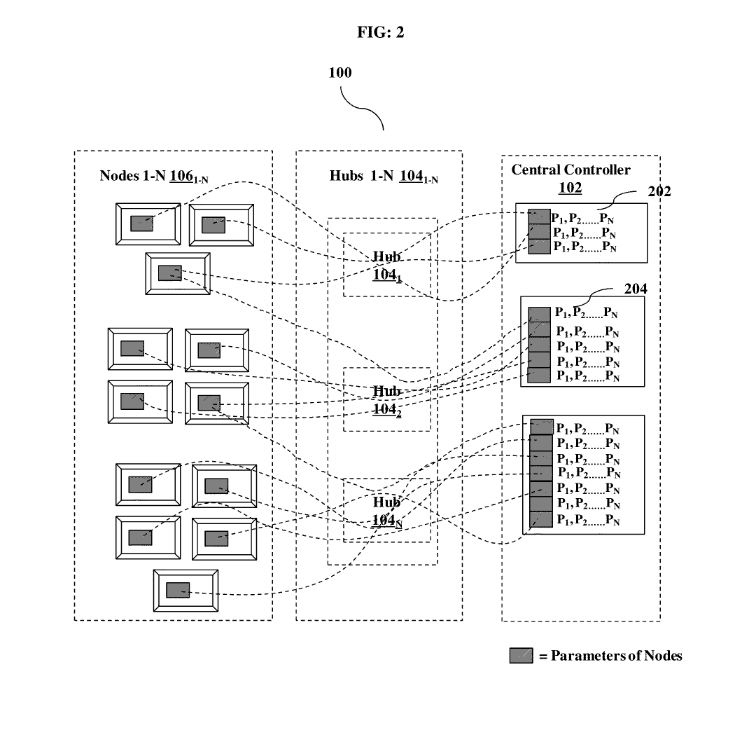

FIG. 2 expands features and functions of the M2M network 100 as described in the FIG. 1, according to embodiments described herein. In an embodiment, each node 106 in the M2M network 100 can send multiple parameters P1, P2 . . . P_{N} using one or more hubs 104_{1-N}. The central controller 102 can be configured to continuously monitor and receive the parameters (P1, P2, . . . P_{N}) associated with each node 106 in the M2M network 100. At the central controller 102, the node parameters received from each the hub 104 can be displayed as a list 202, such as shown in the FIG. 2. The FIG. 2 shows the information flow from the nodes 106 to the hub(s) 104, and from the hubs 104 to the central controller 102. Unlike conventional systems, where previously stored node parameters are used, the proposed system and method allows the central controller 102 to receive changes in the node parameters automatically from the hubs 104 which uses short range communication to communicate with the nodes 106. The usage of short range communications and automatic nature of the system and method may improve the performance of the communication links in the in the M2M network 100 and improve the overall network performance with significantly decreased time and cost.

Further, the hubs 104 can be configured to frequently monitor the parameters associated with the nodes 106. The parameters described herein can include for example, but not limited to, node availability, node characteristics, services offered by the node, the service availability, the service characteristics, the service quality, communication channel, profile data, user preferences, usage data, range, speed, bandwidth, workload, security data, and congestion in the network 100. In an example, the node characteristic parameter described herein can include for example, but not limited to, battery level, communication link/channel information (further including the channel quality derived from derived Signal-to-Noise Ratio (SNR)), different types of communications link used by the nodes (for example, Bluetooth, ZigBee, Wi-Fi, P2P, ultra wideband, and the like), routing information, cost, device mobility, and the like. As the quality of performance of a service provided to user, and the network performance of any M2M network is directly depended on the changes in the node parameters, any change in the capability of the nodes has a direct effect on the performance and responsiveness of the system. The frequent monitoring of the nodes 106 using the hub 104 allows the central controller to identify the transient sensors and determine the availability of the nodes.

Further, in an embodiment, the parameters received and displayed at the central controller 102 can be analyzed to identify the capability of each node 106 present in the M2M network. Based on the identified capabilities of the nodes 106, the central controller 102 can perform various actions to optimize the performance of the M2M network 100. The capabilities of the nodes are identified using a set of rules present in the central controller 102.

In an embodiment, based on the capability identification at the central controller 102, a node (or a set of nodes) can be associated with one or more hubs 104.

Further, the central controller 102 can be configured to ensure that the parameters associated with the services are prioritized in order of appropriateness and requirements of the user based on the one or more rules. The central controller 102 can be configured to include various combinations of elements, such as to provide priorities to each parameter of the M2M network 100. In real-time the priorities may be given using weighing factor, rank ordering methods, stars, ratings, and the like. Furthermore, the rules and prioritization can be implemented/performed in any order/form and other elements, components, steps, and operations, may be added, skipped, deleted, and modified without departing from the scope of the invention.

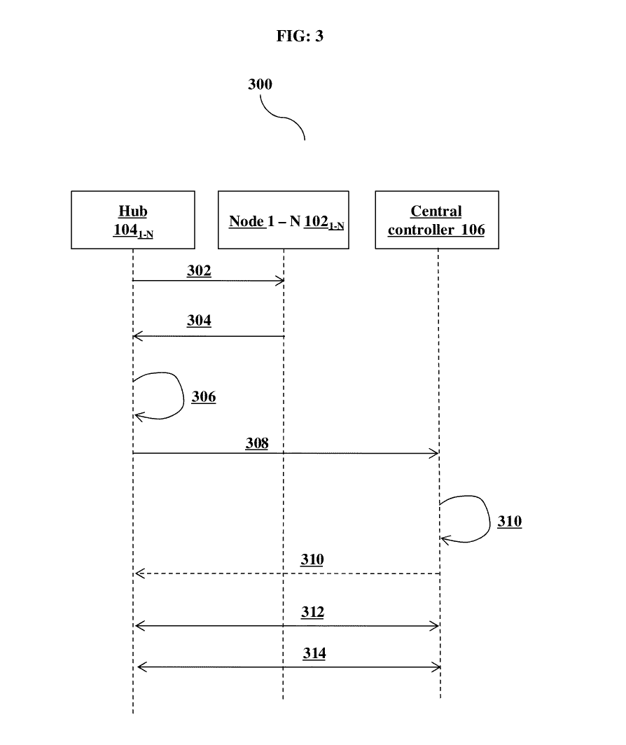

FIG. 3 is a sequence diagram 300 illustrating generally operations performed by the central controller 102 and the hub 104 as described in the FIG. 2, according to embodiments disclosed herein. In an embodiment, at 302, each hub 104 in the M2M network 100 sends a request for parameters to each node 106 in the M2M network 100. The request is sent using one or more short range communications to receive the parameters associated with each node in the M2M network 100. Each hub 104 in the M2M network 100 can be configured to send request for parameter to the nodes 106 within the radio frequency range of the hub 104. In an example, providing information associated with the nodes 106 can involve privacy concerns, such as transmitting the information of the nodes 106 over the M2M network 100 (or any other third-party applications, devices, and networks). Options are available to address privacy concerns. The options may include that an administrator or security applications may be chosen to opt-in to participate or to opt-out to not participate in monitoring or sharing of the information associated with the nodes 106.

At 304, the hub 104 can be configured to receive the parameters sent by the nodes 106 within the radio frequency range of the hub 104. The parameters received at the central controller 102 can include for example, but not limited to, node availability, node characteristics, services offered by the node, the service availability, the service characteristics, the service quality, communication channel, profile data, user preferences, usage data, range, speed, bandwidth, workload, security data, and congestion in the network 100.

At 306, the hub 104 can be configured to consolidate the parameters from each node 106 using one or more consolidation algorithms. The consolidation algorithm allows the consolidation of the received parameters using efficient mechanism to increase the life time of the system and reduce the battery consumption of sensors present in the nodes 106. At step 308, the hub 104 sends the consolidated parameters to the central controller 102.

At step 310, the central controller 102 can be configured to analyze the received parameters to identify the capability of each node 106 in the M2M network 100 based on a plurality of rules. In an embodiment, a value (on scale of 1 to 10) can be assigned to each parameter based on the one or more applicable rules. In an example, the rules can include elements such as for example, but not limited to, node availability, node characteristics, services offered by the node, the service availability, the service characteristics, the service quality, communication channel, profile data, user preferences, usage data, range, speed, bandwidth, workload, security data, user historic activities, user interest, user frequent services, user service usage, user service cost plans, user device battery level, communication link/channel, profile, service quality requirement data, range, speed, bandwidth, workload, congestion, or any other elements indicating the user requirements and needs.

At step 312, the central controller 102 can be configured to determine if any action is to be performed for optimizing the M2M network 100 based on the parameters information of each node. Examples of such actions performed to automatically optimize the network 100, can include for example, but is not limited to, reconfiguring at least one node in said M2M network 100, adding at least one node in the M2M network 100, removing at least one node from the M2M network 100, configuring at least one said node in the M2M network, associating at least one node with at least one hub in the M2M network 100, disassociating at least one node with at least one hub in the M2M network 100, prioritizing currently available nodes, grouping at least one node in the M2M network 100, and the like. At step 314, the hub 104 in the M2M network 100 is configured to frequently monitor the nodes 106 in radio frequency range of the hub 104 and detect changes in the node parameters, such as to automatically optimize the M2M network 100. The frequent monitoring of the parameters can allow the central controller 102 to provide seamless, optimal, personalized, reliable, uninterrupted, and enhanced services to the user.

The various operations or actions described with respect to the FIG. 3 can be performed in the order present, simultaneously, parallel, combination thereof, or in any order. The operations or actions herein are only for illustrative purpose and do not limit the scope of the invention. Further, in some embodiments some of the operations, acts, or steps can be added, skipped, omitted, or modified without departing from the scope of the invention.

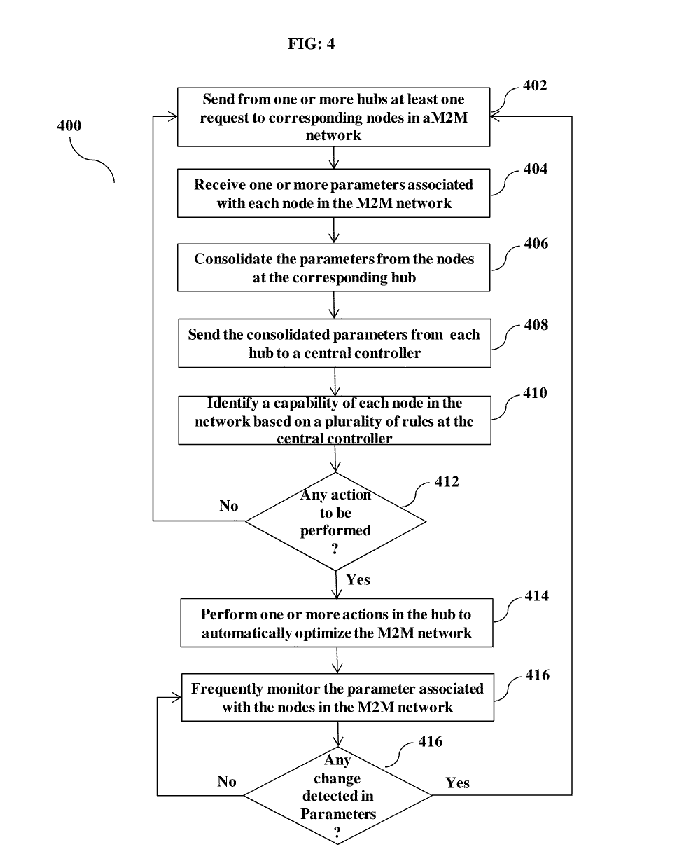

FIG. 4 is a flow chart illustrating a method 400 for automatically optimizing a Machine-to-Machine (M2M) network, according to embodiments disclosed herein. In an embodiment, at 402, the method 400 includes sending from one or more hubs at least one request to corresponding nodes in the M2M network. The request is sent using one or more short range communications to receive at least one parameter associated with each node in the M2M network.

At 404, the method 400 includes receiving the parameters associated with the node associated with the one or more hubs in the M2M network. In an example, the method 400 allows the hub 400 to send the request to the nodes 106 and receive the parameters associated with each node throughout the M2M network 100. The parameters described herein can include for example, but not limited to, node availability, node characteristics, services offered by the node, the service availability, the service characteristics, the service quality, communication channel, profile data, user preferences, usage data, range, speed, bandwidth, workload, security data, and congestion in the network 100.

At 406, the method 400 includes consolidating the parameters from each node. In an example, the method 400 allows the hub 104 to consolidate the parameters from each node using one or more consolidation algorithms. In an embodiment, the hub 104 is configured to use the consolidation algorithms sent by the central controller 102 to consolidate the parameters received from each node in the network 100.

At step 408, the method 400 includes sending the consolidated parameters from the hub 104 to the central controller 102. At step 410, the method 400 includes identifying capability of each node in the network 100 based on plurality of rules at the central controller. A value (on scale of 1 to 10) can be assigned to each parameter based on the one or more applicable rules. In an example, the rules can include elements such as for example, but not limited to, node availability, node characteristics, services offered by the node, the service availability, the service characteristics, the service quality, communication channel, profile data, user preferences, usage data, range, speed, bandwidth, workload, security data, user historic activities, user interest, user frequent services, user service usage, user service cost plans, user device battery level, communication link/channel, profile, service quality requirement data, range, speed, bandwidth, workload, congestion, or any other elements indicating the user requirements and needs.

At step 412, the method 400 includes determining if any action is to be performed to optimize the network based on the information about the consolidated parameters. The method 400 allows the central controller 102 to determine if any action is to be performed based on the plurality of rules associated with the parameters. If no action is to be performed then the method 400 includes repeated the steps 402 through 412.

At step 414, the method 400 includes performing at least one action in at least one hub to automatically optimize the M2M network. In an example, the method 400 allows the central controller 102 to perform one or more actions to automatically optimize the M2M network 100. Examples of such actions performed to automatically optimize the network 100, can include for example, but is not limited to, reconfiguring at least one node in said M2M network 100, adding at least one node in the M2M network 100, removing at least one node from the M2M network 100, configuring at least one said node in the M2M network, associating at least one node with at least one hub in the M2M network 100, disassociating at least one node with at least one hub in the M2M network 100, prioritizing currently available nodes, grouping at least one node in the M2M network 100, and the like. Consider an example, when a set of nodes 106 is consistently visible by more than one hub 104 then the central controller 102 can group a set of nodes and associate them with a particular hub 104 in the network 100. Further, the nodes 106 in the M2M network 100 can be grouped together to optimize the performance of the links in the M2M network 100 based on the identified capabilities of each node in the M2M network 100.Unlike conventional network optimization mechanism which perform optimization of the M2M network based on previously stored parameters of the node, the disclosed method 400 and system allows automatic optimization of the M2M network based on received parameters which are frequently monitored.

At step 416, the method 400 includes frequently monitoring the parameters associated with the node in the M2M network. The method 400 allows each hub 104 in the M2M network 100 to frequently monitor the nodes 106 within the radio frequency range of the hub 104. In an example, the hub 104 can be configured to collect information from the nodes 106 within its radio frequency range at regular intervals of time to provide seamless, optimal, personalized, reliable, uninterrupted, and enhanced services to the user.

At step 418, the method 400 allows each hub 104 in the M2M network 100 to detect changes in the parameters of the nodes in vicinity of the hub 104. Any changes in the parameters can affect the performance, sensitivity, cost, and reliability of the end service provided to the user. On detecting a change in the parameter, the method 400 includes repeating the steps 402 through 416, such as to maximize the overall network performance of the M2M network 100 and provide seamless and uninterrupted service to the user. If no changes are detected the method 400 allows the hubs to frequently monitor the parameters associated with the corresponding node in the M2M network 100. As the node parameters are frequently monitored using the short range communication, the central controller 102 can determine pattern of availability of transient sensors. Consider an example where the node comprises of mobile sensors. As the parameters are frequently monitored using the hubs 104 present in the M2M network 100, the central controller 102 can easily the track the availability of the nodes at a given time in the M2M network 100 and perform various actions to automatically optimize the performance of the M2M network 100 without any user intervention.

In The various actions, units, steps, blocks, and acts described in the method 400 may be performed in the order presented, in a different order, or simultaneously. Further, in some embodiments, some actions, units, steps, blocks, and acts listed in the FIG. 4 may be omitted, added, skipped, and modified without departing from the scope of the invention.

The embodiments disclosed herein can be implemented through at least one software program running on at least one hardware device and performing network management functions to control the network elements. The modules, components, devices, and elements shown in the FIGS. 1-4 include blocks which can be at least one of a hardware device, or a combination of hardware device and software module.

The embodiment disclosed herein specifies a system and method for automatically optimizing a M2M network. The mechanism allows optimization of network 100 by monitoring the nodes in the network through the corresponding hubs using short range communications and accordingly executes the one or more rules embodied in the system thereof to optimize the M2M network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for automatically optimizing a Machine-to-Machine (M2M) network including a central controller configured to communicate with a plurality of nodes controlled using at least one hub, the method comprising:
receiving, at said central controller, at least one parameter associated with each said node from said at least one hub, wherein said at least one hub requests each said node using a short range communication to receive said at least one parameter from each said node;
identifying, at said central controller, a capability of each said node based on a plurality of rules; and
performing at least one action in said at least one hub to automatically optimize said M2M network based on said identified capability of each said node in said M2M network.

2. The method of claim 1, wherein receiving at said central controller at least one parameter associated with each said node from said at least one hub comprises:
sending from said at last one hub at least one request to each said node, wherein said request is sent to receive said at least one parameter associated with each said node in said M2M network;
receiving at said at last one hub said at last one parameter associated with each said node in said M2M network as a response to said request received at each said node;
consolidating at said at last one hub said at least one parameter received from each said node in said M2M network; and
sending from said at last one hub said consolidated parameters to said central controller.

3. The method of claim 1, wherein said at least one parameter comprises at least one of said node availability, said node characteristics, services offered by said node, said service availability, said service characteristics, said service quality, communication channel, profile data, user preferences, usage data, range, speed, bandwidth, workload, security data, and congestion.

4. The method of claim 1, wherein said at least one action comprises at least one of reconfiguring at least one said node in said M2M network, adding at least one node in said M2M network, removing at least one said node from said M2M network, configuring at least one said node in said M2M network, associating said at least node with said at least one hub in said M2M network, disassociating at least said node with said at least one hub in said M2M network, prioritizing currently available nodes, and grouping at least one said node in said M2M network.

5. The method of claim 1, wherein said node comprises a transient sensor.

6. The method of claim 1, wherein said method further comprises displaying at said central controller said at least on parameter information of each said node in said M2M network.

7. The method of claim 1, wherein said method further comprises frequently monitoring said at least one parameter associated with said at least one node in said M2M network.

8. The method of claim 7, wherein said method further comprises dynamically updating display of said at least one parameter information each said node in said M2M network based on an output of said monitoring and said plurality of rules.

9. A system for automatically optimizing a Machine-to-Machine (M2M) network including a central controller communicating with a plurality of nodes controlled using at least one hub, wherein said central controller is configured to:
receive at least one parameter associated with each said node from said at least one hub, wherein said at least one hub requests each said node using a short range communication to receive said at least one parameter from each said node
identify a capability of each said sensor based on a plurality of rules; and
perform at least one action in said at least one hub to automatically optimize said M2M network based on said identified capability of each said node in said M2M network.

10. The system of claim 9, wherein receive at least one parameter associated with each said node from said at least one hub comprises:
send from said at last one hub at least one request to each said node, wherein said request is sent to receive said at least one parameter associated with each said node in said M2M network;
receive at said at last one hub said at last one parameter associated with each said node in said M2M network as a response to said request received at each said node;
consolidate at said at last one hub said at least one parameter received from each said node in said M2M network; and
send from said at last one hub said consolidated parameters to said central controller.

11. The system of claim 9, wherein said at least one parameter comprises at least one of said node availability, said node characteristics, services offered by said node, said service availability, said service characteristics, said service quality, communication channel, profile data, user preferences, usage data, range, speed, bandwidth, workload, security data, and congestion.

12. The system of claim 9, wherein said at least one action comprises at least one of reconfiguring at least one said node in said M2M network, adding at least one node in said M2M network, removing at least one said node from said M2M network, configuring at least one said node in said M2M network, associating said at least node with said at least one hub in said M2M network, disassociating at least said node with said at least one hub in said M2M network, prioritizing currently available nodes, and grouping at least one said node in said M2M network.

13. The system of claim 9, wherein said node comprises a transient sensor.

14. The system of claim 9, wherein said central controller is further configured to display at said central controller said at least one parameter information of each said node in said M2M network.

15. The system of claim 9, wherein said central controller is further configured to frequently monitor said at least one parameter associated with said at least one node in said M2M network.

16. The system of claim 15, wherein said central controller is further configured to dynamically update display of said at least one parameter information each said node in said M2M network based on an output of said monitoring and said plurality of rules.

17. A computer program product comprising a computer executable program code recorded on a computer readable non-transitory storage medium, wherein said computer executable program code when executed causing the said product to:
receive, at said central controller, at least one parameter associated with each said node from said at least one hub, wherein said at least one hub requests each said node using a short range communication to receive said at least one parameter from each said node
identify, at said central controller, a capability of each said node based on a plurality of rules; and
perform at least one action in said at least one hub to automatically optimize said M2M network based on said identified capability of each said node in said M2M network.

18. The computer program product of claim 17, wherein receive at said central controller at least one parameter associated with each said node from said at least one hub comprises:
send from said at last one hub at least one request to each said node, wherein said request is sent to receive said at least one parameter associated with each said node in said M2M network;
receive at said at last one hub said at last one parameter associated with each said node in said M2M network as a response to said request received at each said node;
consolidate at said at last one hub said at least one parameter received from each said node in said M2M network; and
send from said at last one hub said consolidated parameters to said central controller.

19. The computer program product of claim 17, wherein said at least one parameter comprises at least one of said node availability, said node characteristics, services offered by said node, said service availability, said service characteristics, said service quality, communication channel, profile data, user preferences, usage data, range, speed, bandwidth, workload, security data, and congestion.

20. The computer program product of claim 17, wherein said at least one action comprises at least one of reconfiguring at least one said node in said M2M network, adding at least one node in said M2M network, removing at least one said node from said M2M network, configuring at least one said node in said M2M network, associating said at least node with said at least one hub in said M2M network, disassociating at least said node with said at least one hub in said M2M network, prioritizing currently available nodes, and grouping at least one said node in said M2M network.

21. The computer program product of claim 17, wherein said node comprises a transient sensor.

22. The computer program product of claim 17, wherein said computer executable program code when executed causes said product to display at said central controller said at least one parameter information of each said node in said M2M network.

23. The computer program product of claim 17, wherein said computer executable program code when executed causes said product to frequently monitor said at least one parameter associated with said at least one node in said M2M network.

24. The computer program product of claim 23, wherein said computer executable program code when executed causes said product to update display of said at least one parameter information each said node in said M2M network based on an output of one said monitoring and said plurality of rules.
